(19) United States
(12) Patent Application Publication
(10) Pub. No.: US 2015/0012606 A1
(43) Pub. Date: Jan. 8, 2015

(54) System and Method to Trap Virtual Functions of a Network Interface Device for Remote Direct Memory Access

(71) Applicant: Dell Products, LP, Round Rock, TX (US)

(72) Inventor: Hari B. Gadipudi, Hyderabad (IN)

(21) Appl. No.: 13/934,069

(22) Filed: Jul. 2, 2013

(51) Int. Cl. H04L 12/801; H04L 29/08

(52) U.S. Cl. CPC H04L 47/193; H04L 67/1097
USPC 709/212

(57) ABSTRACT

An information handling system includes a processor operable to instantiate a virtual machine on the information handling system, a converged network adapter (CNA) operable to provide a virtual function to the virtual machine, and a trapped virtual function module separate from the CAN. The trapped virtual function is operable to receive data from the virtual machine, add a transport layer header and a network layer header to the data to provide a remote direct memory access (RDMA) packet, and send the RDMA packet to the CNA. The CNA is further operable to add an Ethernet header to the RDMA packet to provide an Ethernet packet, and send the Ethernet packet to a peer information handling system.

### FIELD OF THE DISCLOSURE

This disclosure relates generally information handling systems, and more particularly relates to trapping virtual functions of a network interface device for remote direct memory access.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software resources that may be configured to process, store, and communicate information and may include one or more computer systems, data storage systems, and networking systems. An information handling system can perform remote direct memory access (RDMA) with other information handling systems.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating a host system according to an embodiment of the present disclosure;

FIG. 2 is a flowchart illustrating a method of trapping virtual functions of a network interface device for remote direct memory access; and

FIG. 3 is a block diagram illustrating a generalized information handling system according to an embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

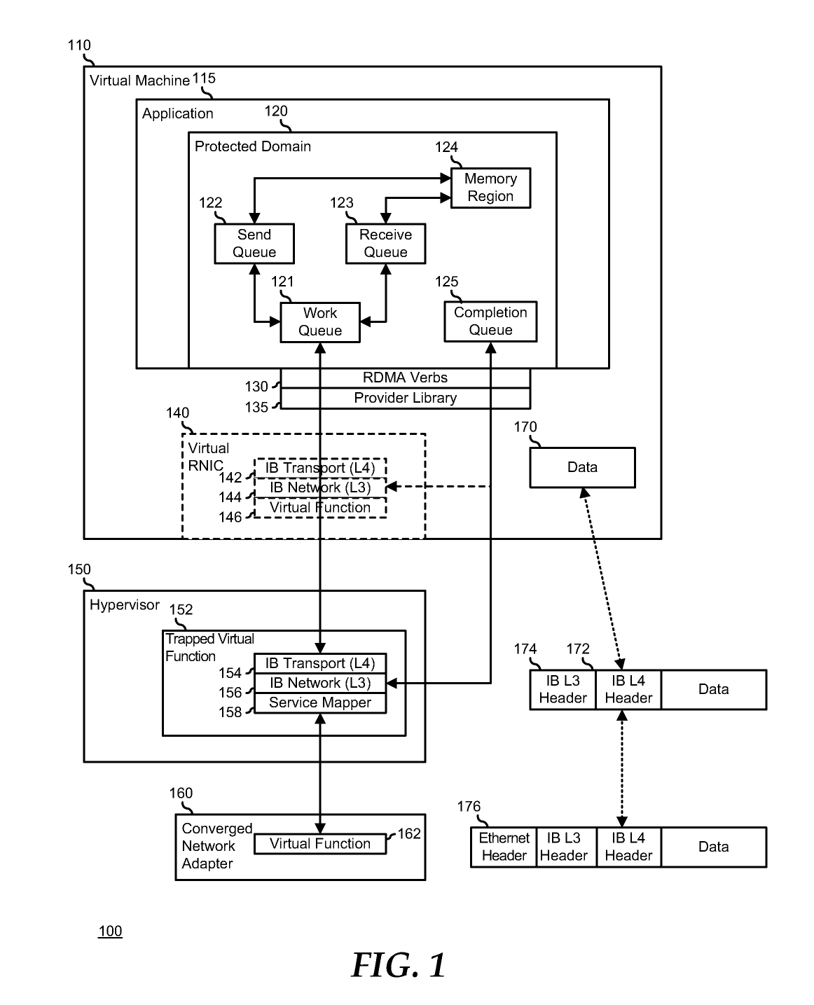

FIG. 1 illustrates an embodiment of a host system 100. For purpose of this disclosure host system 100 can represent an information handling system that includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system can be a personal computer, a laptop computer, a smart phone, a tablet device or other consumer electronic device, a network server, a network storage device, a switch router or other network communication device, or any other suitable device and may vary in size, shape, performance, functionality, and price. Further, an information handling system can include processing resources for executing machine-executable code, such as a central processing unit (CPU), a programmable logic array (PLA), an embedded device such as a System-on-a-Chip (SoC), or other control logic hardware. An information handling system can also include one or more computer-readable medium for storing machine-executable code, such as software or data. Additional components of an information handling system can include one or more storage devices that can store machine-executable code, one or more communications ports for communicating with external devices, and various input and output (I/O) devices, such as a keyboard, a mouse, and a video display. An information handling system can also include one or more buses operable to transmit information between the various hardware components.

Host system 100 includes a virtual machine 110, a hypervisor 150, and a converged network adapter (CNA) 160. Virtual machine 110 represents an abstraction of a hardware-based information handling system that is instantiated by hypervisor 150, and operates to emulate the functions of the hardware-based information handling system on host system 100 to execute one or more processing workloads. As such, hypervisor 150 represents an operating environment that is running on host system 100 to launch virtual machine 110 on the host system and to allocate a virtual function 162 of CNA 160 to provide the virtual machine with access to the resources of a network (not illustrated). In a particular embodiment, host system 100 is coupled via CNA 160 to one or more similar host systems (not illustrated) and performs Remote Direct Memory Access (RDMA) operations with the memories of the one or more host systems. Here, CNA 160 implements Single Root Input/Output Virtualization (SR-IOV) to provide host system 100 with the capacity to present virtual function 162 to virtual machine 100 to implement a virtual Network Interface Card (NIC) for the virtual machine. In a particular embodiment, the RDMA operations include InfiniBand (IB) operations over CNA 160, also referred to as RDMA over Converged Ethernet (RoCE) operations. In a particular embodiment, host system 100 includes one or more additional virtual machines similar to virtual machine 100, and CNA 160 implements additional virtual functions similar to virtual function 162 that are presented to the one or more additional virtual machines.

Virtual machine 110 operates to execute an application 115 that performs RDMA operations with the memories of one or more host systems coupled to CNA 160. In order to perform the RDMA operations, application 115 communicates with a set of RDMA verbs 130 and an associated provider library 135 instantiated on virtual machine 110 to create a protected domain 120 associated with the application. Protected domain 120 operates to securely isolate the resources involved in the RDMA operations from other similar RDMA operations on virtual machine 110. Protected domain 120 includes a work queue 121, a send queue 122, a receive queue 123, an associated memory region 124 of virtual machine 110, and a completion queue 124. Send queue 122 operates to execute RDMA Read, RDMA Write, and RDMA Send operations to work queue 121. The RDMA Read, RDMA Write, and RDMA Send operations are used by an RDMA capable NIC (RNIC) to obtain command and control operations. Receive queue 123 operates to post buffers that are visible to the RNIC and to inform the RNIC as to where to place incoming data from a remote peer information handling system that is participating in the RDMA operations. As such, the buffers presented by receive queue 123 are pre-registered with the RNIC as memory region 124 that represents a contiguous memory region of virtual machine 110 that is reserved for application 115 to perform the RDMA operations. Completion queue 125 provides an asynchronous notification and completion mechanism to allow application 115 to track when a RDMA operation or an error has occurred.

In order for virtual machine 110 to perform RDMA operations, host system 100 needs to instantiate a RNIC. However, many popular and readily available CNAs such as CNA 160 are not operable as RNICs. This is because an RNIC has to be equipped to provide IB-based services as a capability of the virtual function provided to a virtual machine. The IB-based services include IB transport layer (L4) services such as in-order packet delivery, partitioning, channel multiplexing, transport services such as reliable connection, reliable datagram, unreliable connection, and unreliable datagram, and the like. The IB-based services also include IB network layer (L3) services for routing across subnets, such as Global Routing Header (GRH), Global Unique Identifier (GUID), Local Route Header (LRH), Local Unique Identifier (LUID) services, and the like. These IB-based L4 and L3 services offer functionality which is different from the functionality provided by a TCP/IP Offload Engine (TOE) that is common to CNAs.

In order instantiate a RNIC on virtual machine 110, hypervisor 150 includes a trapped virtual function 152 that includes an IB L4 module 154, an IB L3 module 156, and a service mapper module 158. Trapped virtual function 152 operates to inherit the functionality of CNA 160 as provided by virtual function 162. IB L4 module 154 and IB L3 module 156 operate to add the IB transport layer services and IB network layer services, respectively, to the functionality provided by virtual function 162. In this way, virtual machine 110 includes a virtual RNIC (vRNIC) 140 that includes the functionality of IB transport layer services 142, IB network layer services 144, and virtual function 146, thereby providing the virtual machine with the ability to perform RDMA operations. In a particular embodiment, where host system 100 includes additional virtual machines similar to virtual machine 110, and CNA 160 operates to provide additional virtual functions similar to virtual function 162 to provide network access to the additional virtual machines. Here, service mapper 158 operates to bind virtual function 162 to virtual machine 110 and to bind the additional virtual functions to the respective additional virtual machines. Although trapped virtual function 152 is illustrated as being implemented in hypervisor 150, this is not necessarily so, and the trapped virtual function can be implemented elsewhere in host system 100, such as in a stand-alone application, in firmware, in another location in hardware or software, or a combination thereof, as needed or desired.

In an exemplary RDMA operation, application 115 provides data 170 to be transmitted to a peer host system. Data 170 is provided to trapped virtual function 152 to create a packet. Here, IB L4 module 154 adds an IB L4 header 172, and IB L3 module 156 adds an IB L3 header 174. The packet is then provided to CNA 160, where the packet receives an Ethernet header 176, and the packet is sent over the network to the peer host system. In this way, host system 100 operates to provide RoCE functionality to virtual machine 110.

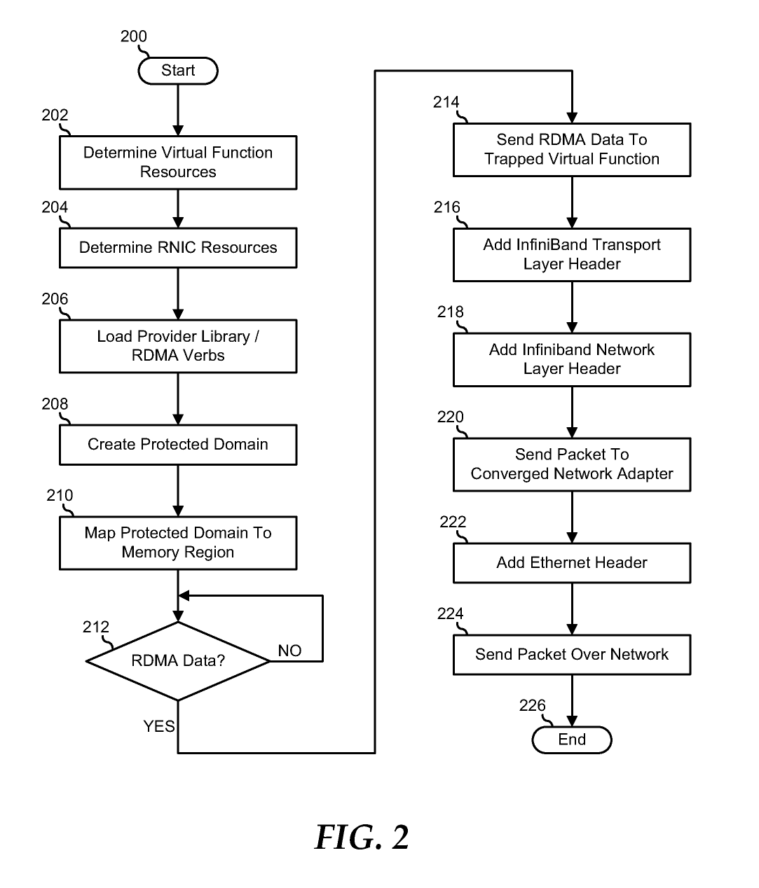

FIG. 2 illustrates a method of trapping virtual functions of a network interface device for remote direct memory access, starting at block 200. The resources provided by a virtual function of a CNA are determined within a host system in block 202. For example, host system 100 can determine that CNA 160 operates to provide virtual function 162 for virtual machine 110. The resources that are needed by the virtual machine to implement a virtual RNIC are determined in block 204. For example, host system 100 can determine any additional resources needed to implement a RNIC and can provide trapped virtual function 152 to provide the additional resources. A provider library and RDMA verbs are loaded by the host system in block 206. For example, host system 100 can load RDMA verbs 130 and provider library 135. The provider library and RDMA verbs are launched to create a protected domain in block 208. For example, RDMA verbs 130 and provider library 135 can be launched to instantiate protected domain 120 on virtual machine 110. The memory region of the protected domain is associated with the application for RDMA operations in block 210. For example, RDMA verbs 130 and provider library 135 can be launched to instantiate protected domain 120 on virtual machine 110, and to associate memory region 124 with application 115. For example, memory region 124 can be associated with application 115.

A decision is made as to whether or not a RDMA operation is to be performed in decision block 212. If not, the “NO” branch of decision block 212 is taken and the method loops to the decision block until a RDMA operation is to be performed. If a RDMA operation is to be performed, the “YES” branch of decision block 212 is taken, and the RDMA data is sent to a trapped virtual function in block 214. For example, data 170 can be sent to trapped virtual function 152. An IB transport layer header is added to the RDMA data in block 216. For example, IB L4 module 154 can add IB L4 header 172 to data 170. An IB network layer header is added to the packet in block 218. For example, IB L3 module 156 can add IB L3 header 174 to the packet. The data packet including the RDMA data, the IB transport layer header, and the IB network layer header, is sent to a CNA in block 220. For example the packet including data 170, IB L4 header 172, and IB L3 header 174 can be sent to CNA 160. The CNA adds an Ethernet header to the packet in block 222. For example, CNA 160 can add Ethernet header 176 to the packet. The resulting packet is sent over the network to the destination host system in block 224, and the method ends in block 226.

The skilled artisan will recognize that, although packet encapsulation is shown and described as an illustrative embodiment, the decapsulation of RDAM data traffic from a peer host system to host system 100 is likewise understood to be envisioned in the present disclosure.

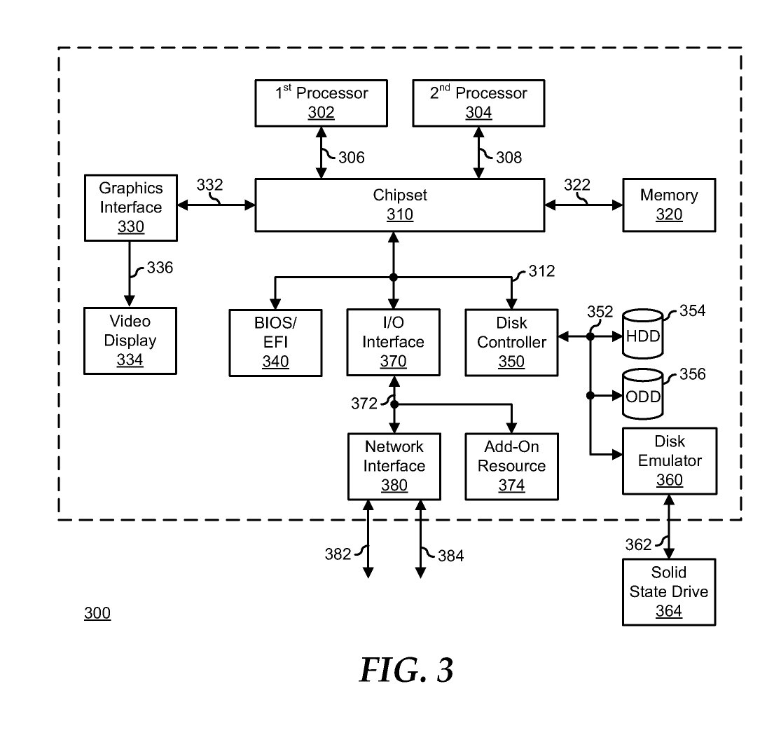

FIG. 3 illustrates a generalized embodiment of information handling system 300. For purpose of this disclosure information handling system 300 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 100 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described above, and operates to perform one or more of the methods described above. Information handling system 300 includes a processors 302 and 304, a chipset 310, a memory 320, a graphics interface 330, include a basic input and output system/extensible firmware interface (BIOS/EFI) module 340, a disk controller 350, a disk emulator 360, an input/output (I/O) interface 370, and a network interface 380. Processor 302 is connected to chipset 310 via processor interface 306, and processor 304 is connected to the chipset via processor interface 308. Memory 320 is connected to chipset 310 via a memory bus 322. Graphics interface 330 is connected to chipset 310 via a graphics interface 332, and provides a video display output 336 to a video display 334. In a particular embodiment, information handling system 300 includes separate memories that are dedicated to each of processors 302 and 304 via separate memory interfaces. An example of memory 320 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 340, disk controller 350, and I/O interface 370 are connected to chipset 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. Chipset 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 340 includes BIOS/EFI code operable to detect resources within information handling system 300, to provide drivers for the resources, initialize the resources, and access the resources. BIOS/EFI module 340 includes code that operates to detect resources within information handling system 300, to provide drivers for the resources, to initialize the resources, and to access the resources.

Disk controller 350 includes a disk interface 352 that connects the disc controller to a hard disk drive (HDD) 354, to an optical disk drive (ODD) 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits a solid-state drive 364 to be coupled to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O interface 370 includes a peripheral interface 372 that connects the I/O interface to an add-on resource 374 and to network interface 380. Peripheral interface 372 can be the same type of interface as I/O channel 312, or can be a different type of interface. As such, I/O interface 370 extends the capacity of I/O channel 312 when peripheral interface 372 and the I/O channel are of the same type, and the I/O interface translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as chipset 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be coupled to external network resources (not illustrated). The network resource can include another information handling system, a data storage system, another network, a grid management system, another suitable resource, or a combination thereof.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system comprising:
a processor operable to instantiate a virtual machine on the information handling system;
a converged network adapter (CNA) operable to provide a virtual function to the virtual machine; and
a trapped virtual function module separate from the CNA and operable to:
receive data from the virtual machine;
add a transport layer header and a network layer header to the data to provide a remote direct memory access (RDMA) packet; and
send the RDMA packet to the CNA;
wherein the CNA is further operable to:
add an Ethernet header to the RDMA packet to provide an Ethernet packet; and
send the Ethernet packet to a peer information handling system.

2. The information handling system of claim 1, wherein:
the transport layer header is an InfiniBand transport layer header; and
the network layer header is an InfiniBand network layer header.

3. The information handling system of claim 2, wherein the transport layer header further comprises at least one of in-order packet delivery, partitioning, channel multiplexing, and transport services.

4. The information handling system of claim 3, wherein the transport services comprise at least one of a reliable connection, a reliable datagram, an unreliable connection, and an unreliable datagram.

5. The information handling system of claim 2, wherein the network layer header further comprises at least one of a Global Routing Header (GRH), a Global Unique Identifier (GUID), a Local Route Header (LRH), and a Local Unique Identifier (LUID).

6. The information handling system of claim 2, further comprising:
a hypervisor operable to launch the virtual machine, wherein the hypervisor comprises the trapped virtual function.

7. The information handling system of claim 1, wherein the trapped virtual function further comprises a service mapper operable to:
map the virtual function to the virtual machine; and
map another virtual function provided by the CNA to another virtual machine instantiated on the information handling system.

8. A method comprising:
instantiating a virtual machine on an information handling system;
providing, by a converged network adapter (CNA) of the information handling system, a virtual function to the virtual machine;
receiving, at a trapped virtual function module of the information handling system and separate from the CNA, data from the virtual machine;
adding, by the trapped virtual function module, a transport layer header and a network layer header to the data to provide a remote direct memory access (RDMA) packet;
sending, by the trapped virtual function module, the RDMA packet to the CNA;
adding, by the CNA, an Ethernet header to the RDMA packet to provide an Ethernet packet; and
sending, by the CNA, the Ethernet packet to a peer information handling system.

9. The method of claim 8, wherein:
the transport layer header is an InfiniBand transport layer header; and
the network layer header is an InfiniBand network layer header.

10. The method of claim 9, wherein the transport layer header further comprises at least one of in-order packet delivery, partitioning, channel multiplexing, and transport services.

11. The method of claim 10, wherein the transport services comprise at least one of a reliable connection, a reliable datagram, an unreliable connection, and an unreliable datagram.

12. The method of claim 9, wherein the network layer header further comprises at least one of a Global Routing Header (GRH), a Global Unique Identifier (GUID), a Local Route Header (LRH), and a Local Unique Identifier (LUID).

13. The method of claim 9, further comprising:
launching, by a hypervisor of the information handling system, the virtual machine, wherein the hypervisor comprises the trapped virtual function.

14. The method of claim 8, further comprising:
mapping, by a service mapper of the trapped virtual function, the virtual function to the virtual machine; and
map, by the service mapper, another virtual function provided by the CNA to another virtual machine instantiated on the information handling system.

15. A non-transitory computer-readable medium including code for performing a method, the method comprising:
instantiating a virtual machine on an information handling system;
providing, by a converged network adapter (CNA) of the information handling system, a virtual function to the virtual machine;
receiving, at a trapped virtual function module of the information handling system and separate from the CNA, data from the virtual machine;
adding, by the trapped virtual function module, an InfiniBand transport layer header and an InfiniBand network layer header to the data to provide a remote direct memory access (RDMA) packet;
sending, by the trapped virtual function module, the RDMA packet to the CNA;
adding, by the CNA, an Ethernet header to the RDMA packet to provide an Ethernet packet; and
sending, by the CNA, the Ethernet packet to a peer information handling system.

16. The computer-readable medium of claim 15, wherein the transport layer header further comprises at least one of in-order packet delivery, partitioning, channel multiplexing, and transport services.

17. The computer-readable medium of claim 16, wherein the transport services comprise at least one of a reliable connection, a reliable datagram, an unreliable connection, and an unreliable datagram.

18. The computer-readable medium of claim 15, wherein the network layer header further comprises at least one of a Global Routing Header (GRH), a Global Unique Identifier (GUID), a Local Route Header (LRH), and a Local Unique Identifier (LUID).

19. The computer-readable medium of claim 15, the method further comprising:
launching, by a hypervisor of the information handling system, the virtual machine, wherein the hypervisor comprises the trapped virtual function.

20. The computer-readable medium of claim 15, the method further comprising:
mapping, by a service mapper of the trapped virtual function, the virtual function to the virtual machine; and
map, by the service mapper, another virtual function provided by the CNA to another virtual machine instantiated on the information handling system.
